(19) United States
(12) Patent Application Publication
(10) Pub. No.: US 2012/0252303 A1
(43) Pub. Date: Oct. 4, 2012

(54) METHOD OF MANUFACTURING AN ORGANIC LIGHT EMITTING DEVICE

(75) Inventors: Manabu Otsuka, Narashino-shi (JP); Taro Endo, Kawasaki-shi (JP); Tomoyuki Hiroki, Mobara-shi (JP); Itaru Takaya, Chiba-shi (JP); Koichi Ishige, Mobara-shi (JP); Nobuhiko Sato, Mobara-shi (JP)

(73) Assignee: CANON KABUSHIKI KAISHA, Tokyo (JP)

(21) Appl. No.: 13/415,317

(22) Filed: Mar. 8, 2012

(30) Foreign Application Priority Data
Mar. 31, 2011 (JP) 2011-079011

(51) Int. Cl. H05B 33/10

(52) U.S. Cl. 445/58

(57) ABSTRACT

Provided is a method of manufacturing an organic light emitting device, which enables each of multiple organic light emitting elements included in the apparatus to emit uniform light. The method of manufacturing an organic light emitting device including multiple auxiliary electrodes in a display region, for electrically connecting an electrode and a circuit, includes the steps of: forming a protective member covering corresponding one of the multiple auxiliary electrodes; forming an organic compound layer; removing the protective member; and forming a second electrode to be electrically connected to the corresponding one of the multiple auxiliary electrodes. The removing of the protective member is carried out by immersing the substrate into a solvent capable of selectively dissolving a constituent material of the protective layer.

### BACKGROUND OF THE INVENTION

1. Field of the Invention

The present invention relates to a method of manufacturing an organic light emitting device.

2. Description of the Related Art

In recent years, as a display apparatus which may replace a liquid crystal display, an organic light emitting device (organic light emitting display) using an organic light emitting element has attracted attention. The organic light emitting device is a self-emissive type display and has characteristics of wide viewing angle and low power consumption. Further, it is conceived that the organic light emitting device has a sufficient responsiveness even to high-speed video signals for high-definition display. Therefore, currently, the organic light emitting device has been developed for practical use.

By the way, the organic light emitting device is classified roughly into two types from the standpoint of a light extraction method, that is, a top emission type in which light is extracted from an upper side of a substrate, and a bottom emission type in which light is extracted from a lower side of the substrate. The top emission type organic light emitting device has characteristics that an aperture ratio is better than that of the bottom emission type organic light emitting device.

Further, in the top emission type organic light emitting device, a second electrode present in a light extracting direction is an electrode made of a light transmissive conductive material. Note that, the light transmissive conductive material has a higher resistance value compared to that of an electrode material made of a metal, and hence depending on a distance from a power supply to the individual organic light emitting elements, the voltage drop differs. Therefore, there is a risk that this difference causes brightness fluctuations in a screen. In order to prevent the brightness fluctuations described above, there is employed a method in which an auxiliary electrode is provided to a predetermined location, and the auxiliary electrode and the second electrode are electrically connected to each other. Note that, the auxiliary electrode is desired to be arranged between elements in consideration of the aperture ratio of the organic light emitting device.

By the way, in the case where the auxiliary electrode is arranged between the elements, when a thin film layer made of a constituent material of an organic compound layer included in the organic light emitting element is formed, a part of the material may adhere on the auxiliary electrode. Here, the constituent material of the organic compound layer has a higher resistance value than that of a constituent material of the second electrode (light transmissive conductive material), and hence when the second electrode is formed under a state in which the constituent material of the organic compound layer is adhered onto the auxiliary electrode, the auxiliary electrode and the second electrode cannot be electrically connected to each other. Therefore, after the organic compound layer is formed, it is necessary to perform a step of removing the constituent material of the organic compound layer adhered onto the auxiliary electrode.

As a specific method of removing the constituent material of the organic compound layer adhered onto the auxiliary electrode, there is known a method proposed in Japanese Patent Application Laid-Open No. 2008-288075. Specifically, there is proposed a method in which the constituent material of the organic compound layer is sublimed through laser light irradiation to the organic compound layer adhering onto auxiliary wiring, thereby exposing the auxiliary wiring.

Further, another method is proposed in Japanese Patent Application Laid-Open No. 2005-116330. Japanese Patent Application Laid-Open No. 2005-116330 proposes a method of physically removing the organic compound layer on the auxiliary wiring. Specifically, there is proposed a method in which a tip end portion of an indenter is brought into contact with the organic compound layer covering the auxiliary wiring, and relative positions of the indenter and the substrate are changed while applying load to the indenter, thereby removing the organic compound layer.

However, when the methods proposed in Japanese Patent Application Laid-Open Nos. 2008-288075 and 2005-116330 are employed, it is difficult to selectively remove the organic compound layer as intended. That is, there occurs a problem that not only the organic compound layer to be removed but also a part of the organic compound layer provided at a pixel portion in the vicinity of the auxiliary electrode is also simultaneously removed. In particular, when there are multiple regions where auxiliary electrodes are provided, it is necessary to remove the respective organic compound layers adhering onto the auxiliary electrodes, and hence the methods proposed in Japanese Patent Application Laid-Open Nos. 2008-288075 and 2005-116330 are repeatedly performed. Then, the probability that a part of the organic compound layer provided to the pixel portion in the vicinity of the auxiliary electrode is also simultaneously removed increases, and hence the yield ratio may decrease.

Further, in the methods proposed in Japanese Patent Application Laid-Open Nos. 2008-288075 and 2005-116330, there also occurs a problem that a fragment of the removed organic compound layer is adhered again to another location. In particular, when a high-definition organic light emitting device is to be manufactured, it is necessary to shorten a gap between the pixels in order to improve the aperture ratio. However, in a case where the auxiliary electrode for electrically connecting an electrode and a circuit to each other is provided between the pixels, when the organic compound layer adhered onto the auxiliary electrode is removed, the fragment of the removed organic compound layer may influence the pixels.

### SUMMARY OF THE INVENTION

The present invention has been made to solve the above-mentioned problems, and therefore has an object to provide a method of manufacturing an organic light emitting device, which enables each of multiple organic light emitting elements included in the apparatus to emit uniform light.

According to the present invention, there is provided a method of manufacturing an organic light emitting device including: multiple organic light emitting elements arranged in a display region of a substrate, each including a first electrode, an organic compound layer, and a second electrode in the stated order from the substrate side; multiple auxiliary electrodes arranged in the display region; and wiring provided on the substrate side with respect to the organic compound layer, the wiring being connectable to an external power supply, the method enabling the second electrode and the wiring to be electrically connected to each other by the multiple auxiliary electrodes, the method including the steps of: forming a protective member covering corresponding one of the multiple auxiliary electrodes; forming the organic compound layer; removing the protective member; and forming the second electrode to be electrically connected to the corresponding one of the multiple auxiliary electrodes. The removing the protective member is carried out by immersing the substrate into a solvent capable of selectively dissolving a constituent material of the protective member.

According to the present invention, the method of manufacturing an organic light emitting device, which enables each of the multiple organic light emitting elements included in the apparatus to emit uniform light, can be provided.

Further features of the present invention will become apparent from the following description of exemplary embodiments with reference to the attached drawings.

### BRIEF DESCRIPTION OF THE DRAWINGS

FIGS. 1A and 1B are schematic views illustrating an example of an organic light emitting device to be manufactured by a method of manufacturing an organic light emitting device according to the present invention, in which FIG. 1A is a plan view of the organic light emitting device, and FIG. 1B is a sectional view taken along the line 1B-1B of FIG. 1A.

FIGS. 2A, 2B, 2C, 2D, and 2E are schematic sectional views illustrating a method of manufacturing an organic light emitting device according to a first embodiment of the present invention.

FIGS. 3A, 3B, 3C, and 3D are schematic sectional views illustrating an example of a forming process of a protective member.

FIGS. 4A, 4B, and 4C are schematic sectional views illustrating a process of manufacturing an organic light emitting element portion.

### DESCRIPTION OF THE EMBODIMENTS

A method of manufacturing an organic light emitting device of the present invention is a method of manufacturing an organic light emitting device including multiple organic light emitting elements arranged in a display region, multiple auxiliary electrodes arranged in the display region, and wiring provided below an organic compound layer forming each of the organic light emitting elements. Here, each of the organic light emitting elements arranged in the display region includes a first electrode, a second electrode, and the organic compound layer arranged between the first electrode and the second electrode. Further, the wiring is electrically connectable to an external power supply, and the auxiliary electrode enables the electrical connection between the second electrode and the wiring. Further, the method of manufacturing an organic light emitting device of the present invention includes the following steps (A) to (D) in the stated order. Note that, the step (C) is performed through immersion of the substrate having the organic compound layer formed therein into a solvent which is capable of selectively dissolving a constituent material of a protective member.

(A) a step of forming the protective member covering the auxiliary electrode

(B) a step of forming the organic compound layer

(C) a step of removing the protective member

(D) a step of forming the second electrode to be electrically connected to the auxiliary electrode

Hereinafter, with reference to the drawings, the method of manufacturing an organic light emitting device according to the present invention is described. Note that, in the following description, a well-known or publicly known technology in the technical field can be applied to parts which are not specifically described or illustrated in the drawings. Further, embodiments described below are merely an example of embodiments of the present invention, and the present invention is not limited to those embodiments.

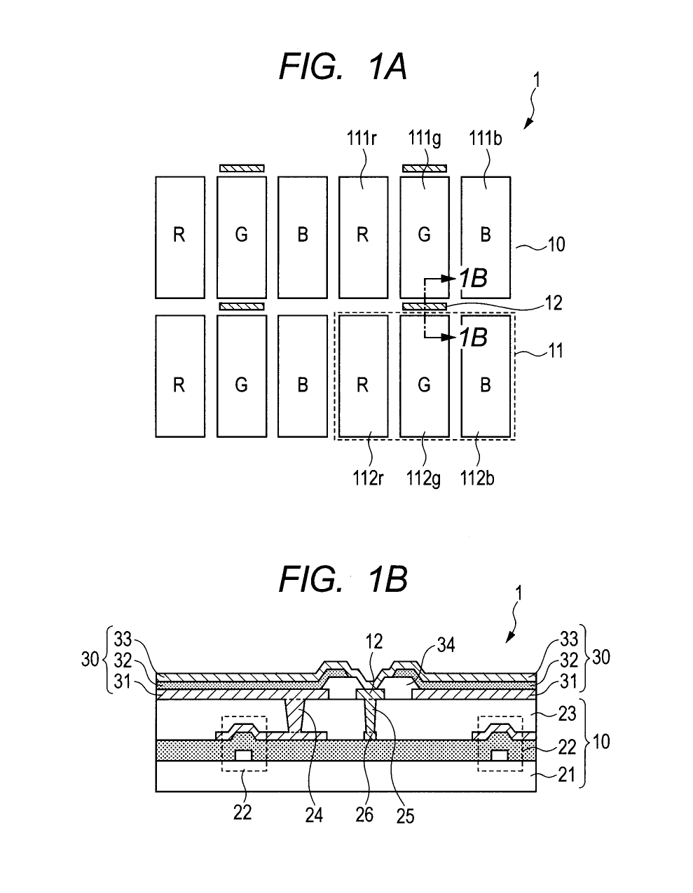

FIGS. 1A and 1B are schematic views illustrating an example of an organic light emitting device to be manufactured by the method of manufacturing an organic light emitting device according to the present invention.

FIG. 1A is a plan view of the organic light emitting device, and FIG. 1B is a sectional view taken along the line 1B-1B of FIG. 1A.

In an organic light emitting device 1 of FIGS. 1A and 1B, multiple pixels 11 are two-dimensionally arranged on a substrate 10 in a predetermined arrangement form. Examples of the arrangement form of the pixels include a stripe arrangement illustrated in FIG. 1A and a delta arrangement, but the arrangement form is not particularly limited in the present invention. Further, in the organic light emitting device 1 of FIGS. 1A and 1B, each of the pixels 11 includes an R sub-pixel 11r, a G sub-pixel 11g, and a B sub-pixel 11b, and the respective sub-pixels are arranged in a stripe manner in the order of RGBRGB . . . for each row. Further, between a G sub-pixel 111g and a G sub-pixel 112g respectively arranged in rows adjacent to each other, an auxiliary electrode 12 to be electrically connected to the second electrode (33), which is to be described later, is provided. Note that, the organic light emitting device 1 of FIGS. 1A and 1B described herein is a top emission type organic light emitting device, but the present invention is not limited thereto, and may be a bottom emission type organic light emitting device. Further, as long as the auxiliary electrode 12 is provided between the sub-pixels and is connectable to wiring 26, the locations and the number thereof are not particularly limited.

In the organic light emitting device 1 of FIG. 1B, the substrate 10 is a member including a base member 21, a drive circuit 22 which is provided on the base member 21 and includes a thin film transistor (TFT), and a planarized passivation layer 23 covering the drive circuit 22.

In the organic light emitting device 1 of FIG. 1B, the pixel 11 includes, as a component thereof, an organic light emitting element portion 30 provided on the planarized passivation layer 23 in a predetermined region. The organic light emitting element portion 30 is a member including a first electrode 31, an organic compound layer provided on the first electrode 31, and a second electrode 33 provided on the organic compound layer 32. Note that, the first electrode 31 is electrically connected to the drive circuit 22 via a contact hole 24. Further, the second electrode 33 is directly connected to the auxiliary electrode 12. Meanwhile, the respective sub-pixels (11r, 11g, and 11b) are divided by a pixel division layer 34 provided at a predetermined position on the planarized passivation layer 23.

The organic compound layer 32 included in the organic light emitting element portion 30 is formed of a single layer or a laminate of multiple layers including at least an emission layer (not shown). Note that, in the present invention, the layer structure of the organic compound layer 32 is not limited as long as the organic compound layer 32 includes the emission layer. The organic compound layer 32 may include, in addition to the emission layer, a hole injection layer, a hole transport layer, an electron blocking layer, a hole blocking layer, an electron transport layer, and the like.

In the organic light emitting device 1 of FIG. 1B, the auxiliary electrode 12 is provided on the planarized passivation layer 23. Further, as illustrated in FIG. 1B, the auxiliary electrode 12 is provided spaced apart from the first electrode 31 by the pixel division layer 34. Further, the auxiliary electrode 12 is electrically connected to the wiring 26 via a contact hole 25. Therefore, as illustrated in FIG. 1B, the auxiliary electrode 12 is a member for electrically connecting the second electrode 33 and the wiring 26 in the drive circuit 22. Further, an arrangement form or an arrangement mode of the auxiliary electrodes 12 are not particularly limited as long as the auxiliary electrode 12 is provided in the display region, specifically, provided between a predetermined sub-pixel and a sub-pixel adjacent to the predetermined sub-pixel as illustrated in FIG. 1A. Note that, the wiring 26 is wiring for connecting the second electrode 33 to an external power supply (not shown), and is provided between the sub-pixels. Further, the wiring 26 is electrically connected to an external connection terminal (not shown), which is connectable to the external power supply.

Next, the components of the organic light emitting device 1 of FIGS. 1A and 1B are described.

The base member 21, which is one of the components of the substrate 10, may be transparent or opaque. Specific examples of the base member 21 to be used include an insulating substrate made of glass, a synthetic resin, or the like, a conductive substrate having an insulating film such as a silicon oxide (SiO₂) film, a silicon nitride (SiN) film, and a silicon oxynitride (SiON) film formed on a surface thereof, and a semiconductor substrate.

The drive circuit 22 included in the substrate 10 is a circuit formed of members necessary for driving the organic light emitting element, for example, a transistor and wiring (for example, wiring 26). A constituent material of a semiconductor layer of the transistor included in the drive circuit 22 may be made of, but not limited to, polysilicon, amorphous silicon, or microcrystalline silicon.

The planarized passivation layer 23, which is one of the components of the substrate 10, is a layer made of an insulating material, and plays a role of planarizing the substrate 10 itself. Further, fine openings can be opened in the planarized passivation layer 23 so as to provide the contact hole 24 for electrically connecting the drive circuit 22 and the first electrode 31 to each other and the contact hole 25 for electrically connecting the wiring 26 and the auxiliary electrode 12 to each other. Therefore, the constituent material of the planarized passivation layer 23 is preferred to be a material which exhibits good pattern accuracy. Examples of the constituent material of the planarized passivation layer 23 include an organic material such as photosensitive polyimide and an inorganic material such as silicon oxide (SiO₂).

The first electrode 31, which is a component of the organic light emitting element portion 30, is preferred to be a thin film electrode made of a metal material having high reflectance, such as Al, Ag, Au, Pt, and Cr, or a light reflective electrode material made of an alloy obtained by combining multiple types of the above-mentioned materials. Further, on this thin film electrode, a transparent electrode made of, for example, ITO or IZO may be further laminated.

The thickness of the organic compound layer 32, which is a component of the organic light emitting element portion 30, is desired to be determined depending on an optical interference distance. Here, the optical interference distance differs depending on respective light emission colors, but is set within the range of several tens of nm to several hundreds of nm, and the organic compound layer 32 is formed in the above-mentioned range. Further, from the viewpoint of luminous efficiency, the organic compound layer 32 is preferred to be an amorphous film.

When the organic compound layer 32 includes any one of the hole injection layer, the hole transport layer, and the electron blocking layer, those layers (hole injection layer, hole transport layer, and electron blocking layer) are all layers made of a hole transport material. Examples of the hole transport material to be used may include a phthalocyanine compound, a triarylamine compound, a conductive polymer, a perylene-based compound, and an Eu-complex, but the present invention is not limited to those materials.

Examples of an organic luminescence material, which is a constituent material of the emission layer included in the organic compound layer 32, include a triarylamine derivative, a stilbene derivative, polyarylene, an aromatic condensed polycyclic compound, an aromatic heterocyclic compound, an aromatic condensed heterocyclic compound, a metal complex compound, a single oligomer or complex oligomer thereof, and other publicly known materials, but the present invention is not limited to those materials. Note that, the emission layer may be formed as a single layer, or as a laminate including multiple layers. When the emission layer is formed of a single layer, multiple types of luminescence materials may be mixed to enable output of white light. With the structure enabling output of white light, it is possible to control output light colors with use of a color filter. Meanwhile, when the emission layer is formed of a laminate including multiple layers, the white light may be formed through formation and lamination of respective luminescence materials having two or more colors. With this structure, it is possible to control the output light colors with use of the color filter.

When the organic compound layer 32 includes any one of the electron transport layer and the hole blocking layer, those layers (electron transport layer and hole blocking layer) are all layers made of an electron transport material. Examples of the electron transport material to be used include Algₐ in which aluminum is coordinated with a 8-hydroxyquinoline trimer, an azomethine-zinc complex, a distyrylbiphenyl derivative, an oxazole derivative, a triazole derivative, and a phenanthroline-based compound.

The second electrode 33 is a light transmissive thin film electrode, and is specifically any one of electrodes described in the following items (i) to (iii).

(i) a transparent conductive electrode made of a transparent conductive material such as ITO and IZO

(ii) a translucent reflective electrode including a metal material (metal material such as Ag and Al, or an alloy including those materials) which is formed to have a thickness capable of exhibiting the light transmissive property (iii) a laminate electrode obtained by combining the electrodes of items (i) and (ii)

When the electrode of item (i) is used as the second electrode 33, the thickness of the second electrode 33 is preferably 30 nm to 300 nm. When the electrode of item (ii) is used as the second electrode 33, the thickness of the second electrode 33 is preferably 5 nm to 20 nm.

The pixel division layer 34 is a member for dividing the sub-pixels (elements) in each unit, to thereby determine the areas of the light emitting region and the auxiliary electrode 12. Note that, the pixel division layer 34 is formed as necessary, and is not necessarily provided between the sub-pixels depending on the embodiment. The pixel division layer 34 is a member made of an insulating material. Examples of the insulating material include an organic material such as photosensitive polyimide and an inorganic material such as silicon nitride (SiN).

The material of the auxiliary electrode 12 to be used may be similar to the constituent material of the first electrode 31. Therefore, the auxiliary electrode 12 can be simultaneously formed with the first electrode 31.

Next, the method of manufacturing an organic light emitting device according to the present invention is described. The method of manufacturing an organic light emitting device according to the present invention includes, as described above, the following steps (A) to (D).

(A) the step of forming the protective member covering the auxiliary electrode

(B) the step of forming the organic compound layer

(C) the step of removing the protective member

(D) the step of forming the second electrode to be electrically connected to the auxiliary electrode

Hereinafter, referring to the drawings as needed, the method of manufacturing an organic light emitting device according to the present invention is described.

### First Embodiment

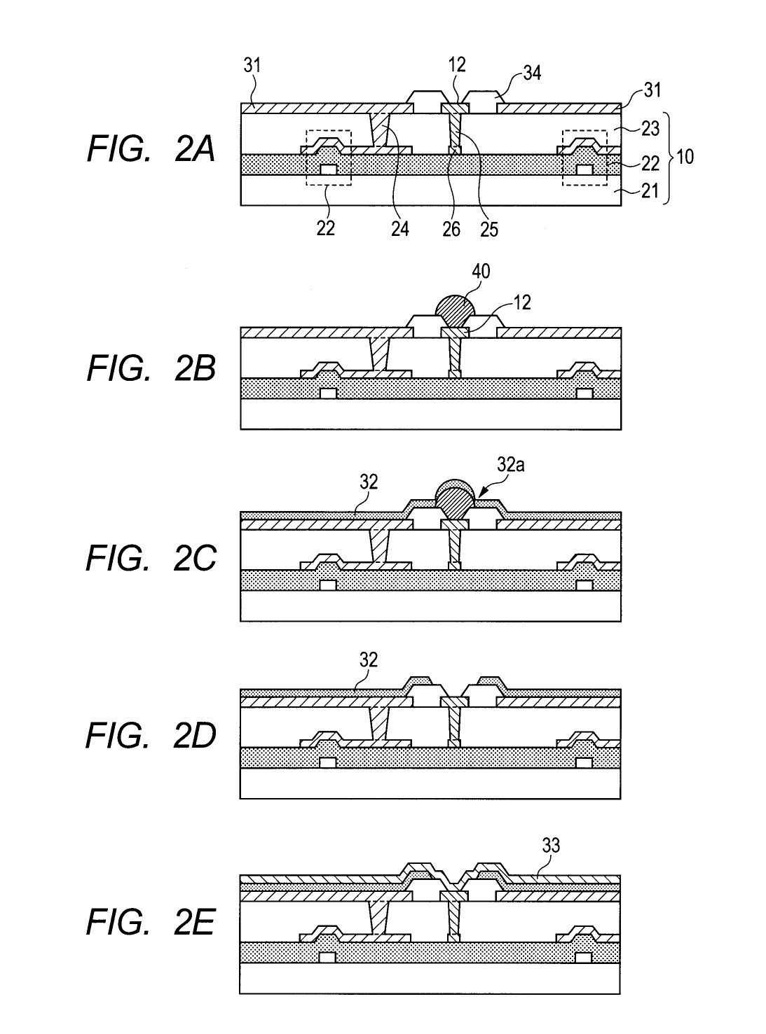

First, a method of manufacturing an organic light emitting element according to a first embodiment of the present invention is described with reference to the drawings as needed. FIGS. 2A to 2E are schematic sectional views illustrating the method of manufacturing an organic light emitting device according to the first embodiment of the present invention.

(1) Step of Forming Substrate Including Electrodes

First, on the substrate 10 in which the base member 21, the drive circuit 22, and the planarized passivation layer 23 are laminated in the stated order, the first electrode 31 and the auxiliary electrode 12 are formed by patterning. A publicly known method can be employed as the method of the patterning. Next, a thin film made of an insulating material is formed on the entire light emitting region, to thereby cover the substrate 10, the first electrode 31, and the auxiliary electrode 12 with the thin film. After that, predetermined patterning is performed, thereby dividing the respective sub-pixels (11r, 11g, and 11b) and forming the pixel division layer 34 having openings in regions at which the respective sub-pixels (11r, 11g, and 11b) and the auxiliary electrode 12 are provided. A publicly known method can be employed as a specific method of forming the pixel division layer 34 by patterning.

Through the above-mentioned step, a substrate including electrodes, in which the first electrode 31 and the auxiliary electrode 12 are formed, is obtained (FIG. 2A). Note that, when a substrate including electrodes, in which the first electrode 31 and the auxiliary electrode 12 are provided on the substrate 10 in advance, can be prepared, this step can be omitted.

(2) Step of Forming Protective Member (Step (A))

After the substrate including electrodes is formed as described above, a protective member 40 is selectively formed on the auxiliary electrode 12 (FIG. 2B).

As the constituent material of the protective member 40 used in this step, there is selected a material capable of selectively dissolving and removing the protective member 40 itself while hardly dissolving the organic compound layer 32 after the organic compound layer is formed in the subsequent step. In the present invention, the organic compound layer 32 is a layer (laminate) made of a water-insoluble material. Therefore, the constituent material of the protective member 40 is preferred to be a water-soluble polymer material.

Examples of the water-soluble polymer material to be used as the constituent material of the protective member 40 include polyvinyl alcohol (PVA), a polyacrylic acid-based polymer, polyethylene glycol (PEG), polyethylene oxide (PEO), polyvinylpyrrolidone (PVP), and other publicly known materials.

Note that, when the above-mentioned water-soluble polymer material is used in this embodiment, the viscosity of a solution containing the water-soluble polymer material is preferred to be adjusted so that the protective member 40 to be formed has, for example, a hemisphere shape, a shape in which an end portion of the protective member is perpendicular to the substrate, or an inverse tapered shape. When the protective member 40 is formed into the above-mentioned shape, the organic compound layer can be prevented from being adhered to the end portion of the protective member 40 when the organic compound layer is formed in the subsequent step by a high-directivity vapor deposition method. Further, in this embodiment, the protective member 40 is formed by selectively applying the solution containing the above-mentioned water-soluble polymer material so as to be within a region on the auxiliary electrode 12, at which the pixel division layer is provided. At this time, in order to enable the protective member 40 to be provided within the region at which the pixel division layer 34 is provided, the amount of the solution containing the above-mentioned water-soluble polymer material is preferred to be adjusted as appropriate.

As a method of applying the solution containing the above-mentioned water-soluble polymer material, there may be employed an ink jet method, a printing method, an imprint method using a mold and the like, and other publicly known methods. Note that, when the solution containing the above-mentioned water-soluble polymer material is applied, the application can be performed multiple times for repeat coating.

After the solution containing the above-mentioned water-soluble polymer material is applied on the auxiliary electrode 12 as described above, the solution is dried. In this manner, as illustrated in FIG. 2B, a substrate in which the protective member 40 is selectively provided on the auxiliary electrode 12 is obtained.

(3) Step of Forming Organic Compound Layer (Step (B))

After the protective member 40 is formed, the organic compound layer 32 is formed (FIG. 2C). First, in the substrate including electrodes illustrated in FIG. 2B, the organic compound layer 32 is formed on the first electrode 31 (FIG. 2C). Note that, as the constituent material of the organic compound layer 32, a publicly known material (luminescence material, electron injection/transport material) may be used as long as the material does not have or have little solubility with respect to pure water. Further, in this embodiment, a part of the organic compound layer 32 is formed on the protective member 40. As illustrated in FIG. 2C, an organic compound layer 32a formed at a boundary line between the pixel division layer 34 and the protective member 40 is formed thinner than the organic compound layer 32 formed at another region.

(4) Step of Removing Protective Member (Step (C))

After the organic compound layer 32 is formed, the protective member 40 is dissolved with use of a solvent capable of dissolving the protective member 40, thereby removing the protective member 40 from above the auxiliary electrode 12 (FIG. 2D). In this step, pure water can be used. However, as necessary, the following measures may be used to facilitate the removal of the protective member 40: ultrasonic vibration; flowing water; heated pure water; a mixed solution obtained by mixing about 10% to 50% of an organic solvent such as isopropyl alcohol into pure water.

That is, in a case where the surface of the protective member 40 is covered with the organic compound layer 32, and the protective member 40 is prevented from being brought into contact with the solvent, in this embodiment, a mixed solution obtained by mixing about 10% to 50% of an organic solvent such as isopropyl alcohol into pure water is used. With this, the organic compound layer 32a covering the boundary between the protective member 40 and the pixel division layer 34 is dissolved, and the mixed solvent enters from the point indicated by the reference symbol 32a to contact with the protective member 40. In this manner, the protective member 40 can be more easily removed. Note that, when the mixed solvent obtained by mixing the pure water and the organic solvent is used, it is preferred that, considering that the part of the organic compound layer 32 is to be dissolved, the etching rate of the organic compound layer present in the uppermost surface be calculated in advance, and the thickness of the organic compound layer on the uppermost surface be adjusted to be thick enough so that the optical interference distance does not change. Further, after the part of the organic compound layer 32 covering the protective member 40 is removed and a part of a surface of the protective member 40 is exposed, the solvent may be changed from the mixed solvent of water and an organic solvent to pure water.

(5) Step of Forming Second Electrode (Step (D))

Next, the second electrode 33 (electrode to be electrically connected to the auxiliary electrode) to be shared by the respective sub-pixels is formed in the entire light emitting region. When the second electrode 33 is formed, a vapor deposition method, a sputtering method, and other publicly known methods may be employed. The second electrode 33 is made of, for example, a cathode material such as Ag and a metal having a low work function such as Mg and is formed by a vapor deposition method or other publicly known methods.

Here, when the second electrode 33 is a cathode (negative electrode), an electron injection layer may be provided as an interposed layer between the organic compound layer 32 and the second electrode 33. That is, a step of forming a layer containing an electron injection material (electron injection layer) may be carried out between the step of removing the protective member and the step of forming the second electrode described above.

The electron injection layer is a layer provided for improving the electron injection property. Further, the electron injection layer is a layer containing the above-mentioned electron injection material, specifically, an alkali metal or an alkaline-earth metal. The following items (a) to (c) are specific forms of the electron injection layer.

(a) a thin film layer made of an alkali metal or an alkaline-earth metal having a low work function

(b) a thin film layer made of a compound of an alkali metal or an alkaline-earth metal (c) an organic compound layer or a metal thin film layer in which an alkali metal, an alkaline-earth metal, or a compound thereof is doped

When the electron injection layer is in the form represented by item (a) or (b), the thickness of the electron injection layer is preferably 0.5 nm to 5 nm. Note that, when the electron injection layer is in the form represented by item (a) or (b), the electron injection layer is present in an island shape, and hence the electrical connection between the cathode and the cathode auxiliary electrode is not hindered.

When the electron injection layer is in the form represented by item (c), an organic compound exemplified as the electron transport material may be used as the organic material to be used. Here, considering that a compound having a low work function such as an alkali metal has an electron-donating ability, an organic material which easily becomes a radical anion, such as a heterocyclic compound and a metal complex compound, is preferably used.

Further, when the electron injection layer is in the form represented by item (c), the electron injection layer easily causes carriers to flow and becomes a state close to a low-resistance conductor, and hence even when the thickness is several tens of nm, the electrical connection between the second electrode 33 and the auxiliary electrode 12 is not hindered.

Note that, an alkali metal, an alkaline-earth metal, or a compound thereof serving as the electron injection material has high reactivity with respect to water. That is, the above-mentioned electron injection material may react with water to lose the electron injection property, which may cause increase in voltage when used as an element. Therefore, it is undesirable to form a layer containing the electron injection material prior to the step of immersing the substrate into a solvent containing pure water as in the manufacturing method of the present invention.

In view of this, when the electron injection layer is provided, as described above, the substrate is desired to be sufficiently dried after the step of removing the protective member.

(6) Encapsulating Step and the like

After the second electrode 33 is formed, the apparatus is encapsulated, to thereby complete the organic light emitting device. In the present invention, a specific method of encapsulating is not particularly limited, and for example, there is a method of encapsulating with use of a hygroscopic agent and a glass cap. Another method is a method of using, as an encapsulating member, a dampproof material such as SiN formed to have a thickness of 1 μm to 10 μm.

### Second Embodiment

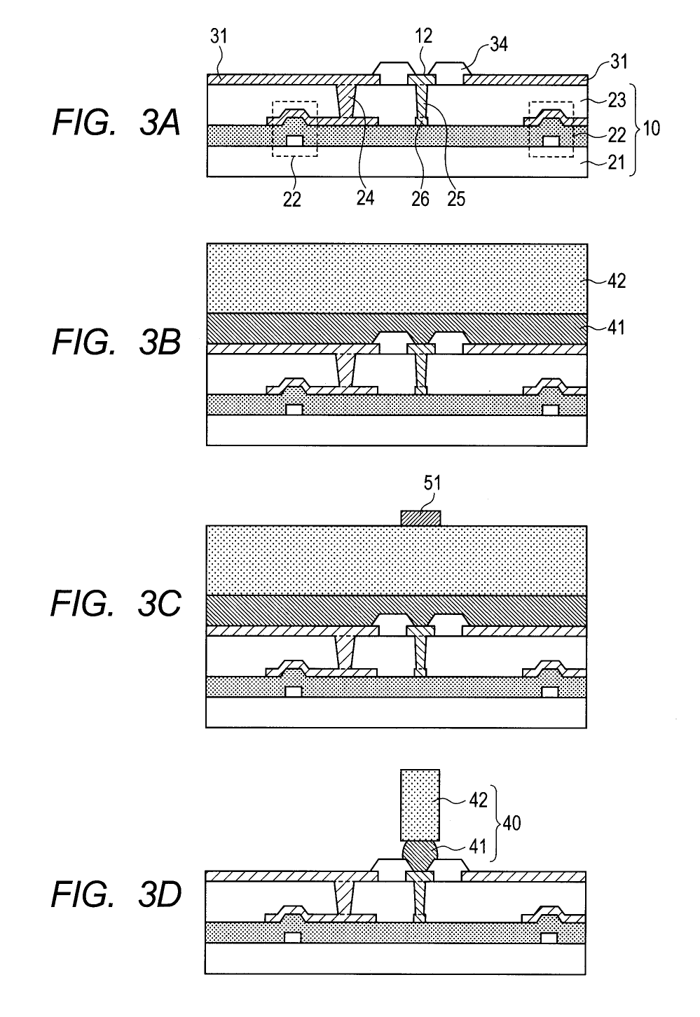

FIGS. 3A to 3D are schematic sectional views illustrating an example of a forming process of a protective member. Further, FIGS. 3A to 3D illustrate a part of the method of manufacturing an organic light emitting device according to a second embodiment of the present invention.

(1) Step of Forming Substrate Including Electrodes

First, similarly to the first embodiment, the substrate including electrodes is formed (FIG. 3A). Note that, the substrate including electrodes may be formed by a method similar to that described in the first embodiment.

(2) Step of Forming Protective Member (Step (A))

Next, a step of forming a protective member for covering the auxiliary electrode 12 is described. In this embodiment, the step of forming the protective member includes the following steps.

(2a) a step of forming a first protective layer covering the auxiliary electrode

(2b) a step of forming a second protective layer on the first protective layer

(2c) a step of processing the first protective layer and the second protective layer by patterning

Hereinafter, Steps (2a) to (2c) are sequentially described.

(2a) Step of Forming First Protective Layer

First, a first protective layer 41 serving as a base of the protective member is formed. Here, the first protective layer 41 is a member playing a role to allow selective removal of the protective member itself while hardly dissolving the organic compound layer 32 after the organic compound layer 32 is formed in the subsequent step. In the present invention, the organic compound layer 32 is a layer (laminate) made of a water-insoluble material. Therefore, the constituent material of the first protective layer 41 is preferred to be a water-soluble organic material, specifically, a water-soluble polymer material. As the water-soluble polymer material to be used as the constituent material of the first protective layer 41, there may be used a material similar to that of the constituent material of the protective member 40 described in the first embodiment.

In this embodiment, the first protective layer 41 is formed through, for example, application of a water-soluble polymer material which is the constituent material of the first protective layer 41.

(2b) Step of Forming Second Protective Layer

Next, on the first protective layer 41, a second protective layer 42 serving as a base of the protective member is formed (FIG. 3B). The second protective layer 42 is a layer for protecting the first protective layer 41 from a solvent and a resist developer for dissolving a resist material to be used in a photolithography step carried out in this embodiment. Therefore, as the constituent material of the second protective layer 42, a material having an insoluble property with respect to those solvent and solution is used.

As the constituent material of the second protective layer 42, a material having a dampproof property is preferred, and for example, silicon nitride (SiN) and other publicly known materials may be used.

In this embodiment, the second protective layer 42 is formed, for example, after the applied layer of the water-soluble polymer material which is the constituent material of the first protective layer 41 is sufficiently dried.

(2c) Step of Processing Protective Layers

Next, through patterning using a photolithography method, the first protective layer 41 and the second protective layer 42 are processed. When the photolithography method is used at the time of processing (patterning) of the protective layer (second protective layer 42), a mask formed by an exposure apparatus such as an MPA or a stepper can be used, and hence a fine process of several μm unit is possible. Therefore, the size and the position of the auxiliary electrode 12 can be determined by the process accuracy of the exposure apparatus such as the MPA or the stepper. Therefore, when a high-definition organic light emitting device is to be manufactured, a sufficient process accuracy can be maintained, and further, the protective member 40 formed of the first protective layer 41 and the second protective layer 42 can be formed on the multiple auxiliary electrodes 12 with good accuracy.

Here, as for a specific method of processing the first protective layer 41 and the second protective layer 42, first, a resist material is applied to the substrate in which the formation of the second protective layer 42 has been finished. Subsequently, by a photolithography method, as illustrated in FIG. 3C, a resist layer 51 is patterned so that only a region corresponding to the auxiliary electrode 12 is masked by the resist layer. Subsequently, the substrate in which the region corresponding to the auxiliary electrode 12 has been masked by the resist layer 51 is subjected to dry etching to perform the patterning of the first protective layer 41 and the second protective layer 42.

Here, the second protective layer 42 can be subjected to etching with use of a chemically reactive etching gas such as CF₄. Note that, the resist layer 51 functions as a mask at the time of this etching (dry etching of the second protective layer 42 using CF₄), and hence the second protective layer 42 is selectively removed by the etching in regions not covered with the resist layer 51.

Next, the first protective layer 41 is processed. Specifically, etching by ashing with use of oxygen is performed. Note that, at the time of this etching, the resist layer 51 which has functioned as a mask for the second protective layer 42 is simultaneously removed. Meanwhile, at the time of this etching, the second protective layer 42 functions as a mask for protecting the first protective layer 41. Therefore, the first protective layer 41 is selectively removed by the etching in regions on which the second protective layer 42 is not placed.

With the above-mentioned steps, the protective member 40, which is formed of the first protective layer 41 and the second protective layer 42 and covers the auxiliary electrode 12, is formed on the auxiliary electrode 12 (FIG. 3D). Note that, as necessary, after the protective member 40 is formed, the second protective layer may be subjected to etching with use of a chemically reactive etching gas such as CF₄. Note that, as illustrated in FIG. 3D, in the step of removing the first protective layer 41 after forming the organic compound layer 32 under a state in which the second protective layer 42 is left unremoved, the second protective layer 42 can be removed together with the organic compound layer 32 formed on the second protective layer 42. Further, as illustrated in FIG. 3D, when the second protective layer 42 is left unremoved, as described later, it is possible to prevent the constituent material of the organic compound layer 32 from directly adhering onto the first protective layer 41 in the step of forming the organic compound layer 32. Therefore, when the substrate is immersed into a solvent capable of dissolving the first protective layer 41 such as pure water, the first protective layer 41 is dissolvable with ease through direct contact with the solvent, and hence the removal of the first protective layer 41 and the organic compound layer 32 is more facilitated.

By the way, when the organic compound layer 32 covers the surface of the first protective layer 41 at the time of forming the organic compound layer 32 in a step of forming the organic compound layer described later, it becomes difficult to remove the protective member 40 in the subsequent step of removing the protective member. In order to prevent this, it is preferred that the etching conditions be adjusted in the processing of the first protective layer 41. Specifically, it is preferred to perform the etching of the first protective layer 41 in such a condition that overetching is performed so that the sectional shape of the first protective layer 41 retreats with respect to the sectional shape of the second protective layer 42. That is, with this etching operation, the first protective layer 41 is formed into a shape which is relatively recessed with respect to the second protective layer 42. That is, in this step, the first protective layer 41 is preferred to be processed and formed so as to satisfy the following conditions (i) and (ii).

(i) the first protective layer 41 is formed so that a part of the first protective layer 41 is hidden behind the second protective layer 42

(ii) through the above-mentioned etching (overetching), the first protective layer 41 is processed so that at least the part of the first protective layer 41 hidden behind the second protective layer 42 is exposed even after the subsequent step (step of forming organic compound layer) is performed

Further, the first protective layer 41 is particularly preferred to be subjected to overetching particularly at a boundary between the first protective layer 41 and the second protective layer 42 and the vicinity thereof, thereby processing the first protective layer 41 into a tapered shape as illustrated in FIG. 3D.

(3) Step of Forming Organic Compound Layer (Step (B))

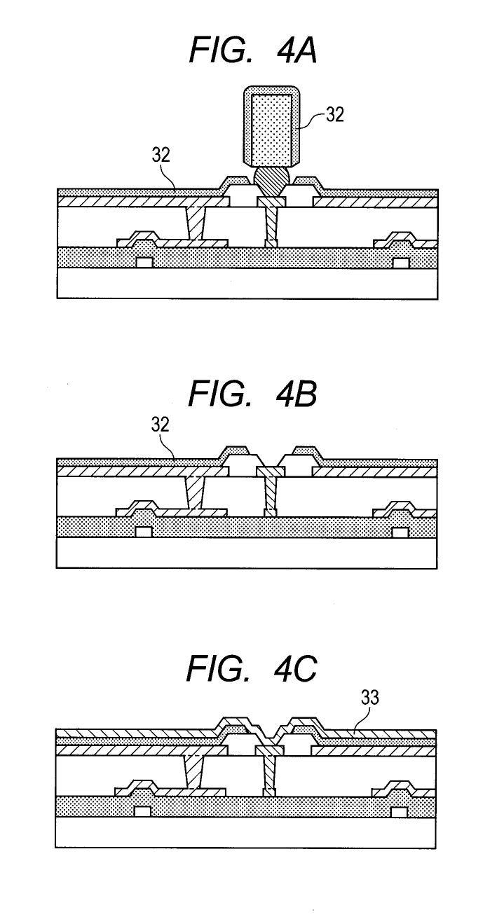

Next, the components of the organic light emitting element portion 30 are sequentially formed. FIGS. 4A to 4C are schematic sectional views illustrating a process of manufacturing the organic light emitting element portion. Note that, the process illustrated in FIGS. 4A to 4C is a continuation of the process illustrated in FIGS. 3A to 3D.

First, in the substrate including electrodes illustrated in FIG. 3D, the organic compound layer 32 is formed on the first electrode 31 (FIG. 4A). Note that, as the constituent material of the organic compound layer 32, a publicly known material (luminescence material, electron injection/transport material) may be used as long as the material does not have or have little solubility with respect to pure water. Further, the organic compound layer 32 may be formed by a publicly known method. Here, through the above-mentioned setting of the etching conditions so that, when the first protective layer 41 is processed, the first protective layer 41 is subjected to overetching by a larger amount as compared to that in the processing of the second protective layer 42, the constituent material of the organic compound layer 32 is less liable to be adhered to a side wall of the first protective layer 41. Further, when the first protective layer 41 is processed into a tapered shape, the constituent material of the organic compound layer 32 is less liable to be adhered to the side wall of the first protective layer 41.

(4) Step of Removing Protective Member (Step (C))

Next, through dissolving of the first protective layer 41 with use of a solvent capable of dissolving the first protective layer 41, the protective member 40 is removed from above the auxiliary electrode 12 (FIG. 4B). The solvent to be used in this step is pure water or a mixed solvent containing pure water. Note that, when pure water is used, the pure water may be heated as necessary. Further, as the mixed solvent containing pure water, a mixed solvent containing pure water and alcohol such as isopropyl alcohol may be used. Note that, it is preferred that, considering that a part of the organic compound layer is to be dissolved when the mixed solvent containing alcohol is used, the etching rate of the organic compound layer present in the uppermost surface be calculated in advance, and the thickness of the organic compound layer on the uppermost surface be adjusted to be thick enough so that the optical interference distance does not change. Further, when the protective member is removed, the dissolving may be progressed with use of ultrasonic vibration or flowing water.

Further, in this step, the organic compound layer 32 formed on the protective member 40 is removed together with the protective member 40. Note that, after this step and prior to the subsequent step, the entire substrate is desired to be dewatered and dried.

(5) Step of Forming Second Electrode and the Like (Step (D))

After the protective member is removed, the second electrode 33 is formed on the organic compound layer and the auxiliary electrode 12 (FIG. 4C), and the apparatus itself is encapsulated to complete the organic light emitting device. As for the method of forming the second electrode 33 and the method of encapsulating the apparatus, the methods described in the first embodiment can be employed.

Note that, also in this embodiment, similarly to the first embodiment, the step of forming the layer containing the electron injection material (electron injection layer) may be performed between the step of removing the protective member and the step of forming the second electrode.

In the above, the embodiments of the present invention have been described, but the manufacturing method of the present invention is also applicable to a form in which the organic light emitting element portions are arranged in a laminated manner or a form in which multiple electrodes are provided as a tandem structure. Further, the manufacturing method of the present invention is applicable even when the drive circuit and an intermediate electrode or the second electrode are to be electrically connected to each other.

Further, in the above-mentioned embodiments, the wiring 26 is arranged inside the substrate 10, but the present invention is applicable even when a member corresponding to the wiring 26 is arranged on the substrate (on the planarized passivation layer 23) so as to function as auxiliary wiring or the like. That is, the present invention is applicable even when the auxiliary electrode is provided to electrically connect the wiring and the second electrode to each other.

As described above, according to the manufacturing method of the present invention, it is possible to cause the organic light emitting device thus formed to emit uniform light.

Further, according to the present invention, even in a case of a high-definition organic light emitting device in which the distance between the auxiliary electrode and the pixel is small, it is possible to obtain an organic light emitting device capable of causing uniform light emission.

Hereinafter, the present invention is described by means of examples, but the present invention is not limited to those examples.

### Example 1

The organic light emitting device illustrated in FIGS. 1A and 1B was formed by a method described in the following.

(1) Step of Forming Substrate Including Electrodes

First, the substrate including electrodes illustrated in FIG. 2A was formed. Here, the substrate 10 illustrated in FIG. 2A includes the base member 21, the drive circuit 22 provided on the base member 21 in the display region, and the planarized passivation layer 23 provided on the drive circuit 22. Further, on the substrate 10 illustrated in FIG. 2A, there are formed the first electrode 31 and the auxiliary electrode 12 for electrically connecting the second electrode (33) to be described later and the wiring 26 to each other. Further, the first electrode 31 and the auxiliary electrode 12 illustrated in FIG. 2A are each an electrode obtained by laminating an Al alloy thin film layer and ITO. After the substrate 10 illustrated in FIG. 2A was formed, the substrate 10 was subjected to plasma processing using a CF₄ gas, thereby performing hydrophobizing processing to the surface of the auxiliary electrode 12.

(2) Step of Forming Protective Member

Next, by an ink jet method, an aqueous solution of polyvinylpyrrolidone (PVP) was applied so as to cover the auxiliary electrode. Note that, when the solution of PVP was applied, the dropping amount was adjusted in advance so that, after the application, the liquid droplets of the solution of PVP to be placed on the auxiliary electrode had a hemisphere shape with a height of 3 μm to 4 μm. Next, heating was performed at 120° C. for 10 minutes to sufficiently dry the liquid droplets. Thus, the protective member 40 was selectively formed on the auxiliary electrode 12. Next, the substrate 10 in which the protective member had been formed was introduced into a vacuum film forming apparatus. Next, the substrate 10 in which the protective member 40 had been formed was subjected to vacuum baking in the vacuum film forming apparatus at 120° C. for 5 minutes to perform dewatering processing, and then dried air was introduced into the vacuum apparatus to perform UV ozone processing for 10 minutes. Thus, a surface of an anode (first electrode 31) was cleaned.

(3) Step of Forming Organic Compound Layer

Next, on the first electrode 31, there was formed the organic compound layer 32 in which the hole transport layer, the emission layer, and the electron transport layer were laminated in the stated order. First, an α-NPD film was formed to form the hole transport layer. Next, the emission layer was formed. Note that, a metal mask was used to perform color division and the emission layer was formed for each emission color. Further, materials represented in the following table were used when the emission layer of each color was formed.

TABLE 1

| | Host | Dopant |
|---|---|---|
| R emission layer | CBP | Ir(piq)₃ |
| G emission layer | Alq₃ | Coumarin 6 |
| B emission layer | Anthracene derivative | Perylene |

Next, a film made of bathophenanthroline, which has an electron acceptor property, was formed to form the electron transport layer.

Note that, the thickness of the organic compound layer 32 of each color was adjusted depending on each emission color while using a metal mask as necessary so that the optical interference condition from the emission layer to the anode (first electrode 31) was proper. Further, the total thickness of the organic compound layers of the respective colors was set as appropriate within the range of 30 nm to 300 nm.

Next, the substrate in which the formation of the electron transport layer had been finished was immersed into a tank containing a solution obtained by mixing isopropyl alcohol into pure water so that the isopropyl alcohol was 50%. Then, the protective member 40 formed on the auxiliary electrode 12 was removed together with the organic compound layer 32 provided on the protective member 40. With this, the auxiliary electrode 12 was exposed on the surface of the substrate 10.

At this time, the etching rate of the electron transport layer with respect to the solution was calculated in advance, and the thickness of the electron transport layer was adjusted.

Next, the substrate was sufficiently rinsed in pure water. Then, the substrate 10 was introduced into the vacuum apparatus to be subjected to vacuum baking at 110° C. for 20 minutes, thereby performing dewatering processing. After that, the substrate 10 was sufficiently cooled in the vacuum apparatus.

(4) Step of Forming Second Electrode

Next, on the organic compound layer 32, Ag and Mg were co-evaporated so that the ratio therebetween was 8:2, thereby forming the second electrode 33. Here, the thickness of the second electrode (AgMg film) 33 was 12 nm.

Next, the substrate 10 in which the formation of the second electrode 33 had been finished was transferred into a glove box coupled to the vacuum evaporation apparatus. Then, encapsulation was performed in a nitrogen atmosphere by a cap glass containing a desiccant. With the above-mentioned steps, the organic light emitting device was obtained.

The organic light emitting device thus obtained was supplied with direct current to cause light emission. As a result, uniform light emitting characteristics were confirmed in the plane.

### Example 2

An organic light emitting device was manufactured by the process described in the second embodiment.

Hereinafter, description is made with reference to the drawings as needed.

(1) Step of Forming Substrate Including Electrodes

First, the substrate including electrodes described in FIG. 3A was formed by a method similar to that in Example 1.

(2) Step of Forming First Protective Layer

Next, polyvinylpyrrolidone (PVP) and pure water were mixed to prepare a 5 wt % aqueous solution. Next, a drop of the aqueous solution was put on the substrate including electrodes formed earlier. Then, a spin coater was used to form a film having a thickness of 500 nm. After that, the thin film thus formed was heated and dried at 120° C. for 10 minutes to form the first protective layer 41.

(3) Step of Forming Second Protective Layer

Next, the substrate in which the first protective layer 41 had been formed was put into the vacuum apparatus. Then, a silicon nitride (SiN) film was formed on the first protective layer 41 by CVD to form the second protective layer 42. At this time, the thickness of the second protective layer 42 was 2 μm (FIG. 3B).

(4) Step of Processing Respective Protective Layers (Step of Forming Protective Member)

Next, on the second protective layer 42, a resist material (AZ1500) was applied, and the resist layer 51 was formed by a spin coater. At this time, the thickness of the resist layer 51 was 2 μm. Next, the resist layer 51 was heated and dried at 120° C.

Next, with use of a photomask having a shielding portion for a region in the display region of the light emitting device, at which the auxiliary electrode was provided, the resist layer 51 was subjected to exposure by an MPA, and development was performed by an alkaline developer. With this, the resist layer was patterned, to thereby form a mask formed of the resist layer 51 (FIG. 3C).

Next, the substrate 10 in which the resist layer 51 thus patterned had been formed was introduced into a dry etching apparatus. Next, CF₄, which is a chemically reactive etching gas with respect to SiN, was introduced into a chamber, to thereby perform patterning of the SiN film by dry etching. At this time, patterning was performed under the conditions set in advance so that overetching was obtained by 10% with respect to the SiN film thickness.

Subsequently, oxygen was introduced, and the first protective layer 41 was patterned through etching of the PVP with use of the patterned SiN film as a mask. At this time, the first protective layer 41 was patterned under such conditions that a residue of the PVP corresponding to the constituent material thereof did not remain, and overetching was obtained by 10% with respect to the film thickness.

(5) Step of Forming Organic Compound Layer

The substrate 10 in which the protective member had been formed on the auxiliary electrode 12 as described above was introduced into the vacuum film forming apparatus. Then, the organic compound layer 32 formed of the hole transport layer, the emission layer, and the electron transport layer was formed with use of a material and procedure similar to those of Example 1. Note that, the electron transport layer was formed based on the etching rate of the electron transport layer with respect to a mixed solvent obtained by mixing pure water and isopropyl alcohol at a ratio of 4:1, and based on the thickness of the electron transport layer calculated based on this etching rate.

Next, the substrate in which the formation of the electron transport layer had been finished was immersed into a tank containing a solution obtained by mixing isopropyl alcohol into pure water so that the isopropyl alcohol was 20%. Then, the first protective layer 41 formed on the auxiliary electrode 12 was removed together with the second protective layer 42 and the organic compound layer 32. With this, the auxiliary electrode 12 was exposed on the substrate surface.

Next, the substrate 10 was sufficiently rinsed in pure water. Next, the substrate 10 was introduced into the vacuum apparatus to be subjected to vacuum baking under a temperature condition of 110° C. for 20 minutes, thereby performing dewatering processing. Next, the substrate 10 was sufficiently cooled in the vacuum apparatus, and the electron injection layer was formed by a procedure described below.

Specifically, on the organic compound layer (electron transport layer) 32 or on the auxiliary electrode 12, bathophenanthroline and cesium carbonate (Cs CO₃) were co-evaporated so that the volume ratio therebetween was 7:3, thereby forming the electron injection layer. At this time, the thickness of the electron injection layer was 60 nm. Next, an IZO film was formed on the electron injection layer by a sputtering method, thereby forming the second electrode 33. At this time, the thickness of the second electrode was 50 nm.

Next, the substrate in which the formation of the second electrode 33 had been finished was transferred into a glove box coupled to the vacuum evaporation apparatus. Then, encapsulation was performed in a nitrogen atmosphere by a cap glass containing a desiccant. With the above-mentioned steps, the organic light emitting device was obtained.

The obtained organic light emitting device was supplied with direct current to cause light emission. As a result, as in Example 1, uniform light emitting characteristics were confirmed in the plane.

### Example 3

In section (4) of Example 2, when the first protective layer 41 was processed (patterned), overetching was performed so that the shape of the first protective layer 41 became a tapered shape in cross section as illustrated in FIG. 3D. The organic light emitting device was manufactured by a method similar to that of Example 2 except that, when the substrate was immersed into the tank after the processing, ultrasonic vibration was used to remove the protective member 40. Hereinafter, a method of processing the first protective layer 41 and a method of removing the protective member 40 according to this example are described.

First, after the second protective layer 42 (SiN film) was patterned by a method similar to that of Example 2, the first protective layer 41 (PVP film) was subjected to etching under such a condition that overetching was performed by 10% with respect to the thickness. Next, the first protective layer 41 (PVP film) was further subjected to etching at the boundary between the first protective layer 41 and the second protective layer 42 (SiN film) and the vicinity thereof. With this, the first protective layer 41 having a tapered shape in cross section was formed. Further, similarly to Example 2, the substrate in which the electron transport layer had been formed on the protective member 40 was immersed into a tank containing a solution obtained by mixing isopropyl alcohol into pure water so that the isopropyl alcohol was 20%. Further, the tank was placed inside an ultrasonic vibration apparatus. Then, ultrasonic vibration was used to remove the first protective layer 41 formed on the auxiliary electrode 12 together with the second protective layer 42 and the organic compound layer 32. Thus, the auxiliary electrode 12 was exposed on the substrate surface.

The obtained organic light emitting device was supplied with direct current to cause light emission. As a result, uniform light emitting characteristics were confirmed in the plane.

### Comparative Example 1

The organic light emitting device was manufactured by a method similar to that of Example 3 except that, in Example 3, prior to the formation of the first protective layer 41, the electron injection layer was formed on the organic compound layer (electron transport layer) 32. The organic light emitting device was manufactured by a method similar to that of Example 3 except that the electron injection layer was formed prior to the removal of the protective layer. Note that, the electron injection layer formed in this comparative example was formed with the same material and composition ratio as those of Example 3.

The obtained organic light emitting device was supplied with direct current, but light emission was not observed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-079011, filed Mar. 31, 2011, which is hereby incorporated by reference herein in its entirety.

What is claimed is:

1. A method of manufacturing an organic light emitting device including:
multiple organic light emitting elements arranged in a display region of a substrate, each including a first electrode, an organic compound layer, and a second electrode in the stated order from the substrate side;
multiple auxiliary electrodes arranged in the display region; and
wiring provided on the substrate side with respect to the organic compound layer, the wiring being connectable to an external power supply,
the method enabling the second electrode and the wiring to be electrically connected to each other by the multiple auxiliary electrodes,
the method comprising the steps of:
forming a protective member covering corresponding one of the multiple auxiliary electrodes;
forming the organic compound layer;
removing the protective member; and
forming the second electrode to be electrically connected to the corresponding one of the multiple auxiliary electrodes,
wherein the removing the protective member is carried out by immersing the substrate into a solvent capable of selectively dissolving a constituent material of the protective member.

2. The method of manufacturing an organic light emitting device according to claim 1, wherein:
the forming of the protective member comprises:
forming a first protective layer covering the corresponding one of the multiple auxiliary electrodes;
forming a second protective layer on the first protective layer; and
processing the first protective layer and the second protective layer by patterning; and
the removing of the protective member is carried out by immersing the substrate into a solvent capable of selectively dissolving a constituent material of the first protective layer.

3. The method of manufacturing an organic light emitting device according to claim 2, wherein:
the first protective layer comprises a layer made of an organic material soluble in at least water;
the second protective layer comprises a layer made of a dampproof material;
the patterning comprises patterning using a photolithography method; and
the processing of the first protective layer and the second protective layer is carried out by dry etching.

4. The method of manufacturing an organic light emitting device according to claim 2, wherein the processing of the first protective layer and the second protective layer comprises:
forming the first protective layer so that a part of the first protective layer is hidden behind the second protective layer; and
processing the first protective layer so that, even after the forming of the organic compound layer is carried out, at least the part of the first protective layer hidden behind the second protective layer is exposed.

5. The method of manufacturing an organic light emitting device according to claim 1, further comprising, between the removing of the protective member and the forming of the second electrode to be electrically connected to the corresponding one of the multiple auxiliary electrodes, forming a layer containing an electron injection material,
wherein the electron injection material comprises a material containing at least one of an alkali metal and an alkaline-earth metal.
